(19) United States
(12) Patent Application Publication
(10) Pub. No.: US 2019/0255365 A1
(43) Pub. Date: Aug. 22, 2019

(54) DESCENDING APPARATUS FOR EMERGENCY ESCAPE

(71) Applicant: SM2 CO., LTD., Daegu (KR)

(72) Inventor: Sa Yun Jang, Daegu (KR)

(21) Appl. No.: 16/226,251

(22) Filed: Dec. 19, 2018

(30) Foreign Application Priority Data
Feb. 21, 2018 (KR) 10-2018-0020273

(51) Int. Cl. A62B 1/18; A62B 1/10; A62B 1/16

(52) U.S. Cl. CPC A62B 1/18; A62B 1/16; A62B 1/10

(57) ABSTRACT

In a descending apparatus for emergency escape, a first winding part around which a wire rope is wound and a second winding part positioned above the first winding part and rotating to allow the wire rope unwound from the first winding part to be re-wound therearound to generate braking power are configured on an inner side of a case, a decelerating device controlling a descending rate of the descending apparatus by reducing a rotation rate of the second winding part by the braking power generated according to rotation of the second winding part when the wire lope is unwound as the descending apparatus descends are configured on both sides of the first and second winding parts, and an operating lever adjusting a descending rate of the descending apparatus by controlling a rotation rate of the second winding part according to an operation of an escaper when descending using the descending apparatus is configured at an upper portion of the case, and a handle 46 is provided to allow the wire rope to be wound therearound to re-use the descending apparatus.

Since a structure of the descending apparatus is simplified, in case of an emergency, an escaper, without being panicked, may simply operate the descending apparatus to descend to the ground, and thus, an accident may be prevented. Also, when using the descending apparatus, the escaper may easily adjust a speed during descending and quickly operate such as adjust a speed, stop, and the like, during descending to cope with various dangerous situations that may occur during descending, and thus, safety of using the descending apparatus may be enhanced. In addition, after the descending apparatus is used, the unwound wire rope may be wound again, and the wound wire may not be unwound, whereby the descending apparatus may be used again.

### CROSS-REFERENCE TO RELATED APPLICATIONS

This patent application claims priority under 35 U.S.C. § 119 to Korean Patent Application No. 10-2018-0020273, filed on Feb. 21, 2018, in the Korean Intellectual Property Office, the disclosure of which is incorporated by reference herein in its entirety.

### BACKGROUND OF THE INVENTION

### Field of the Invention

The present invention relates to an improvement of a descending apparatus used for an emergency escape in the event of a fire in a high-rise building.

### Description of the Related Art

Buildings such as apartments, multiplex housing, and commercial buildings tend to be high rise but mortality is rapidly increasing in fire incidents due to poor means of emergency escape.

In case of fire in a building, various interior decorations with high flammability may be burnt and a large amount of toxic gas may be generated, making it practically impossible to evacuate through elevators or emergency stairs. In addition, release of a toxic gas may lead to casualties before a rescue team reaches the emergency site, and thus, it is required for sufferers to actively handle the corresponding situation, compared to any other risky situations.

In order to actively handle the risky situation, a sufferer may use a descending apparatus to escape from a building in fire. However, most of the existing descending apparatuses has a complicated structure using a decelerator, which are high in manufacturing cost, not easy to adjust a descending rate according to a safety and emergency situation, involving risky factors in terms of use, require continuous maintenance due to the complicated structure, and are not easy for even an ordinary person to handle due to a heavy weight and feel pressure to use, and thus, have not been put to practical use.

To improve this, Korean Patent Registration No. 10-0501233 discloses “Descending Life Line for Emergency Escape” previously registered by the applicant of the present application.

The above-mentioned related art document provides a descending life line having a simple structure for easy access and allowing an escaper (i.e., he or she who escapes) to easily adjust a descending rate to safely descend to reach the ground. In addition to this, descending apparatuses may need to be improved to ensure safe descending to the ground in an emergency.

### RELATED ART DOCUMENT

### Patent Document

(Patent document 1) Korean Patent Registration No. 10-0501233, “Descending Life Line for Emergency Escape”

### SUMMARY

An aspect of the present invention provides a descending apparatus for emergency escape, which has a simple structure for easy access and improved safety to allow an escaper to safely descend to reach the ground in an emergency.

Another aspect of the present invention provides a descending apparatus for emergency escape, which allows for continuous use.

According to an aspect of the present invention, there is provided a descending apparatus for emergency escape, in which a first winding part 4 around which a wire rope 102 is wound and a second winding part 5 positioned above the first winding part 4 and rotating to allow the wire rope 102 unwound from the first winding part 4 to be re-wound therearound to generate braking power are configured on an inner side of a case, a decelerating device 10 controlling a descending rate of the descending apparatus 100 by reducing a rotation rate of the second winding part 5 by the braking power generated according to rotation of the second winding part 5 when the wire lope 102 is unwound as the descending apparatus 100 descends are configured on both sides of the first and second winding parts 4 and 5, and an operating lever 40 adjusting a descending rate of the descending apparatus 100 by controlling a rotation rate of the second winding part 5 according to an operation of an escaper when descending using the descending apparatus is configured at an upper portion of the case.

In the present invention, since a structure of the descending apparatus is simplified, in case of an emergency, an escaper, without being panicked, may simply operate the descending apparatus to descend to the ground, and thus, an accident may be prevented.

Also, when using the descending apparatus, the escaper may easily adjust a speed during descending and quickly operate such as adjust a speed, stop, and the like, during descending to cope with various dangerous situations that may occur during descending, and thus, safety of using the descending apparatus may be enhanced.

In addition, after the descending apparatus is used, the unwound wire rope may be wound again, and the wound wire may not be unwound, whereby the descending apparatus may be used again.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating a configuration of a descending apparatus for emergency escape according to an embodiment of the present invention;

FIG. 2 is an exploded perspective view of a descending apparatus for emergency escape according to an embodiment of the present invention;

FIG. 3 is a front view illustrating an internal configuration of a descending apparatus for emergency escape according to the embodiment of the present invention;

FIG. 4 is a cross-sectional view illustrating a configuration of a descending apparatus for emergency escape according to an embodiment of the present invention;

FIGS. 5, 6, and 7 are detailed views illustrating a configuration of a decelerating device of the present invention;

FIG. 8 is a cross-sectional view illustrating another embodiment of the present invention in which two left and right descending apparatus for emergency escape are installed;

FIGS. 9 and 10 are detailed views of a handle of the present invention; and

FIG. 11 is a view illustrating a descending apparatus in a state of being used according to an embodiment of the present invention.

### DETAILED DESCRIPTION

Hereinafter, embodiments of the present invention will be described in detail with reference to the accompanying drawings.

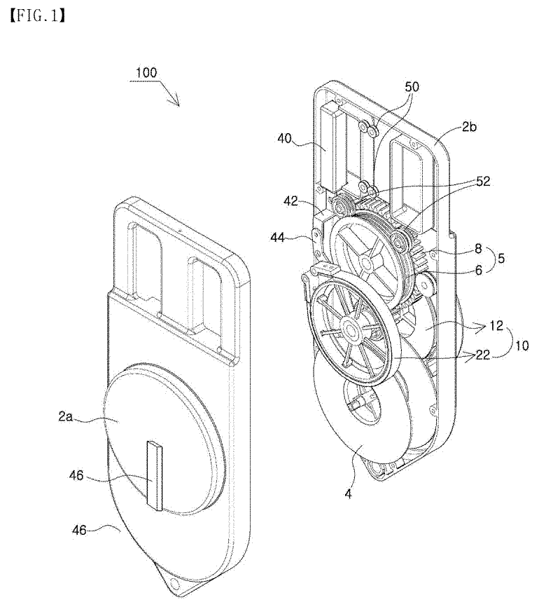

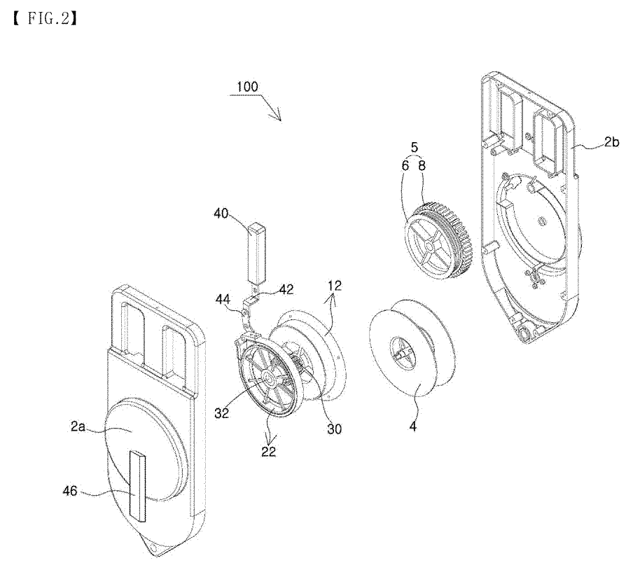

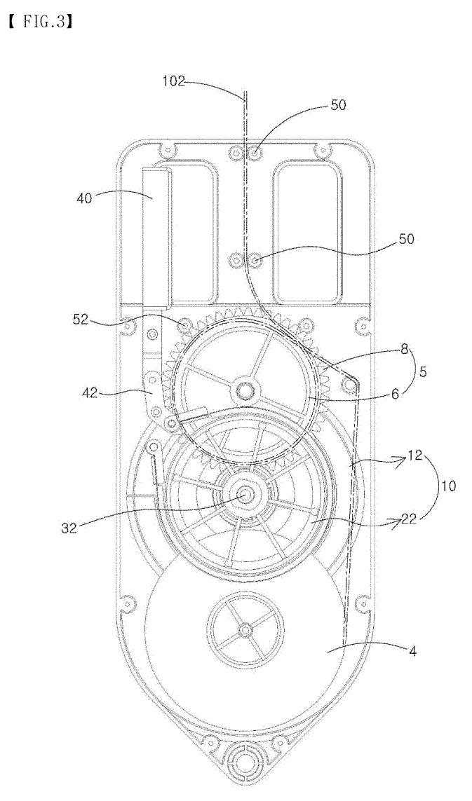

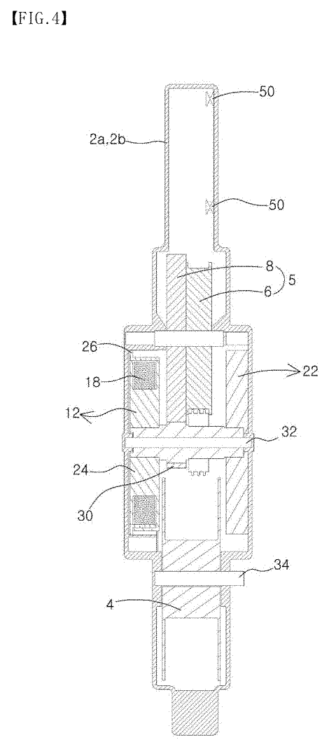

FIG. 1 is an internal perspective view of a descending apparatus for emergency escape according to an embodiment of the present invention, FIG. 2 is an exploded perspective view of the descending apparatus for emergency escape of FIG. 1, FIG. 3 is a front view illustrating an internal configuration of the descending apparatus for emergency escape of FIG. 1, and FIG. 4 is a cross-sectional view of the descending apparatus for emergency escape of FIG. 1.

In a descending apparatus 100 according to the present invention, a first winding part 4 around which a wire rope 102 is wound and a second winding part 5 positioned above the first winding part 4 and rotating to allow the wire rope 102 unwound from the first winding part 4 to be re-wound therearound to generate braking power are configured on an inner side of a case, a decelerating device 10 controlling a descending rate of the descending apparatus 100 by reducing a rotation rate of the second winding part 5 by the braking power generated according to rotation of the second winding part 5 when the wire lope 102 is unwound as the descending apparatus 100 descends are configured on both sides of the first and second winding parts 4 and 5, and an operating lever 40 adjusting a descending rate of the descending apparatus 100 by controlling a rotation rate of the second winding part 5 according to an operation of an escaper when descending using the descending apparatus is configured at an upper portion of the case.

The first winding part 4 is wound with the wire rope 102 for using the descending apparatus 100 for emergency escape and the wound wire rope 102 is formed by twisting several strands of steel wire such that it may withstand a weight when the descending apparatus 100 is used.

The second winding part 5 around which the wire rope 102 descending to be unwound using the descending apparatus 100 is wound again is installed above the first winding part 4, and braking power preventing the descending apparatus 100 from free-falling is generated according to rotation of the second winding part 5 around which the wire rope 102 is wound.

The configuration in which braking power is generated according to rotation of the second winding part 5 will be described together when a configuration of the decelerating device 10 is described hereinafter.

The second winding part 5 includes a winding roller 6 around which the wire rope 102 unwound from the first winding part 4 is wound, a first gear 8 fixed to and installed on a side surface of the winding roller 8 and rotating together with the winding roller 6, and a plurality of auxiliary rollers 52 guiding the wire rope 102 to be wound around the winding roller 6.

In the present invention, in order to prevent the problem of the related art in which the wire rope 102 is cut off as the weight of an escaper is entirely applied to the first winding part 4 when the descending apparatus 100 is used or the wire rope 102, which is being wound around the first winding part 4, is entangled as a heavy weight is applied to the wire rope 102, and the like, the weight is distributed.

That is, a force applied to the wire rope 102 is distributed to the first winding part 4 and the second winding part 5, whereby safety may be enhanced when the descending apparatus 100 is used.

As the wire rope 102 unwound from the first winding part 4 is wound around the winding roller 6 of the second winding part 5, the winding roller 6 rotates, the first gear 8 rotates according to rotation of the winding roller 6, and a second gear 30 engaged with the first gear 8 rotates, generating braking power by the decelerating device 10.

The wire rope 102 is wound around the winding roller 6 a plurality of turns, which is to prevent a problem that sliding occurs due to frictional contact between metals so the wire rope 102 slides to rapidly descend.

The decelerating device 10 includes a first braking part 12 generating braking power upon receiving a rotational force from the first gear 8 of the second winding part 5, a second braking part 22 generating braking power as the escaper using the descending apparatus 100 operates the operating lever 40 to adjust a descending rate, and the second gear 30 connected to the first and second braking parts 12 and 22 by a deceleration rotary shaft 32 and rotating in mesh with the first gear 8 installed on an upper side to transmit braking power.

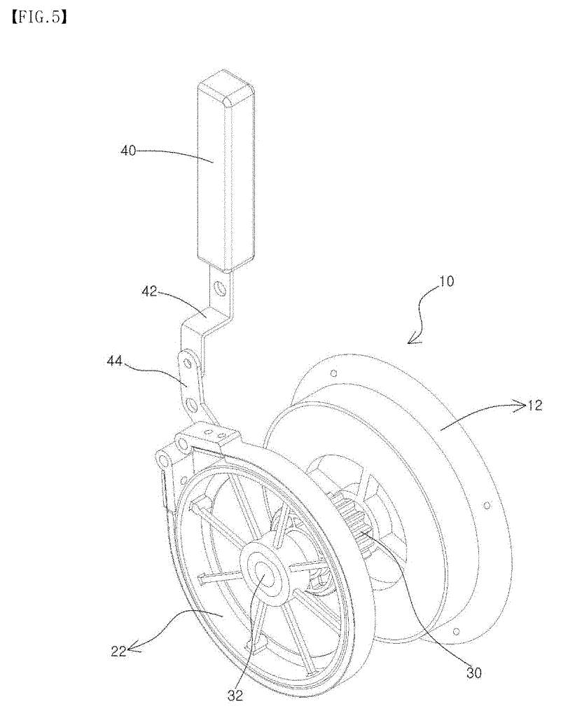

The principle of generating braking power through the first and second braking parts 12 and 22 will be described with reference to FIGS. 5 to 7.

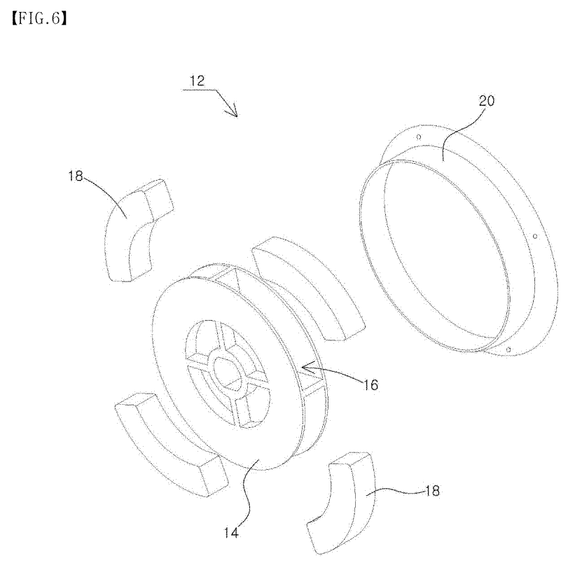

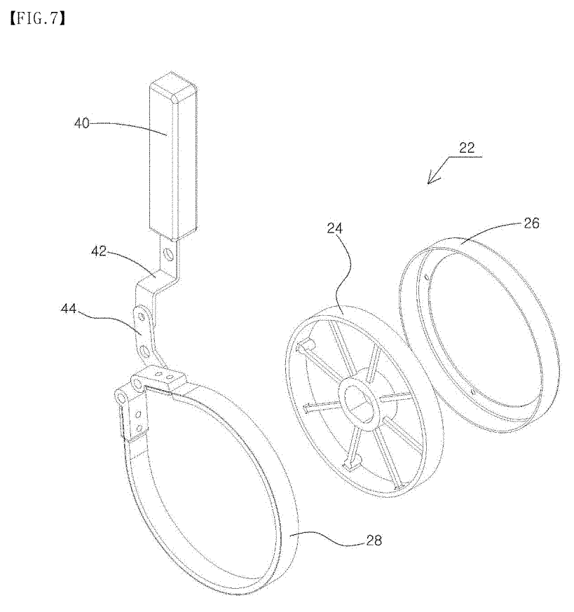

FIG. 5 is a perspective view illustrating a configuration of the decelerating device 10 of the present invention, and FIGS. 6 and 7 are exploded perspective views illustrating a configuration of the first and second braking parts 12 and 22.

Referring to FIG. 6, the first braking part 12 includes a brake pad wheel 14 having space parts 16 formed by a plurality of partitions, brake pads 18 respectively positioned in the space parts 16, and a friction band 20 adjusting a rotation rate of the brake pad wheel 14 according to frictional force with the brake pad 18.

In the present invention, a rotation rate of the brake pad wheel 14 is reduced by a frictional force between the brake pad 18 and the friction band 20, whereby the first gear 8 is decelerated by the second gear 30 rotating together with the brake pad wheel 14 to cause the winding roller 6 to slowly rotate and the wire rope 102 unwound through the second winding part 5 to be slowly unwound, and accordingly, the descending apparatus 100 may slowly be lowered, rather than free-falling, when descending.

Referring to a configuration of deceleration of the brake pad wheel 14, as the wire rope 102 wound around the winding roller 6 of the second winding part 5 is drawn out upwards, the second gear 30 engaged with the first gear 8 dependently rotates at a high speed and the second gear 30 and the brake pad wheel 14 fixed to the second gear 30 are rotated together by the deceleration rotary shaft 32.

Here, the brake pad 18 provided in the space part 16 of the brake pad wheel 14 is pushed outwards by a centrifugal force due to a rotational force to generate a frictional force with the friction band 20 installed on an outer surface of the brake pad 18, and a rotation rate of the brake pad wheel 14 is reduced by the generated frictional force.

The rotation rate of the decelerated brake pad wheel 14 is again transmitted to the first gear 8 via the second gear 30 so that the second winding part 5 is slowly rotated, and accordingly, the wire rope 102 wound around the second winding part 5 is slowly unwound and the descending apparatus 100 slowly descends.

In the present invention, the wire rope 102 is gradually unwound by the first braking part 12 as mentioned above so that the descending apparatus 100 may be slowly lowered, and the second braking part 22 may be configured to allow the escaper of the descending apparatus 100 to adjust a descending rate by himself or by herself or to temporarily stop.

Referring to FIG. 7, the second braking part 22 includes a brake drum 24 fixed and rotated by the second gear 30 and the deceleration rotary shaft 32, a brake lining 26 integrally fixed to and installed on an outer side of the brake drum 24, and a brake shoe 28 reducing a rotation rate of the brake drum 24 by a frictional force between the brake shoe 28 and the brake lining 26.

When the descending apparatus 100 descends, if the escaper does not operate the operating lever 40, the descending apparatus 100 slowly descends by the first braking part 12, and when the escaper pulls the operating lever 40, a descending rate of the descending apparatus 100 may be lowered or the descending apparatus 100 may be stopped.

In detail, when the escaper pulls the operating lever 40, an operating bar 42 is pulled, a connecting pin 44 linked to the brake shoe 28 is pulled, and a frictional force is generated between the brake shoe 28 and the brake lining 26 to brake rotation of the brake drum 24 integrally formed with the brake lining 26.

The braked rotation of the brake drum 24 causes the second gear 30 to be rotated through the deceleration rotary shaft 32 and decelerates the first gear 8 rotated in mesh with the second gear 30, and accordingly, rotation of the first winding part 4 may be reduced in speed and the descending apparatus 100 may be slowly lowered.

Depending on an emergency situation, the escaper may pull the operating lever 40 with all his strength to stop the descent of the descending apparatus 100.

In this embodiment of the present invention, the operating lever 40 is illustrated such that the escaper may operate the operating lever 40 with one hand. However, in order to increase braking power or for an escaper who has a weak grip, the operating lever 40 may also be configured such that the escaper may grip the operating lever 40 with his both hands to simultaneously operate it to adjust a descending rate of the descending apparatus 100.

When the escaper descending on the descending apparatus 100 reaches the ground, the escaper may rotate the first winding part 4 with the handle 46 installed at the first winding part 4 to re-wind the wire rope 102 so that the descending apparatus 100 may be used again.

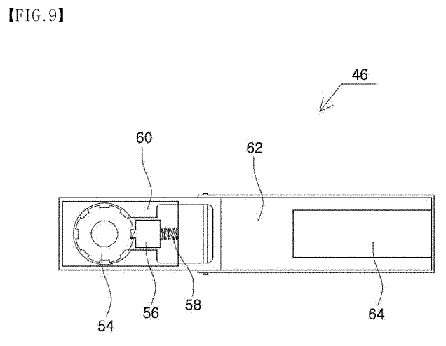

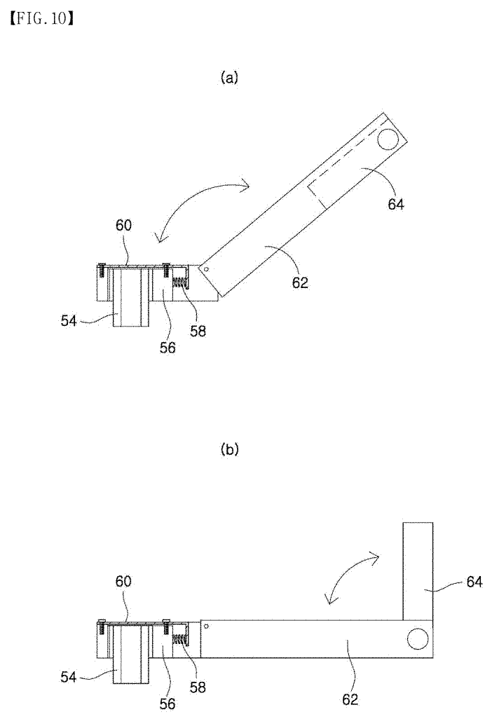

FIGS. 9 to 10 are views illustrating a way in which the handle 46 of the present invention is used.

The handle 46 includes a rotary shaft 54 connected to the first winding part 4 and rotating the handle 46 such that the wire rope 102 is wound around the first winding part 4, an arrest part 56 turning the handle 46 to rotate the rotary shaft 54 such that the wire rope 102 is wound and preventing backward rotation of the rotary shaft 54 such that unwinding does not occur, a cover 62 covering the rotary shaft 54 and the arrest part 56 so as not to be exposed to the outside when the wire rope 102 is not wound, and a handle part 64 allowing the user to grip it to turn the handle 46.

The rotary shaft 54 is rotatably installed in the handle 46, and one side of the rotary shaft 54 is connected to the first winding part 4 so that, as the rotary shaft 54 rotates, the first winding part 4 rotates and the wire rope 102 is wound around the first winding part 4.

In the present invention, in order to rotate the rotary shaft 54, the arrest part 56 is installed in the handle 46, and when the handle 46 is turned in a state in which the rotary shaft 54 is connected to the first winding part 4, an arrest piece of the arrest part 56 may be caught in an arrest recess formed in the rotary shaft 54 so as to be rotated together.

Here, the arrest piece has a sloped surface formed on one side thereof, so that when the rotary shaft 54 rotates in a reverse direction of a direction in which the wire rope 102 is turned to be wound, the arrest piece is not caught in the arrest recess such that the wire rope 102 wound on the first winding part 4 is not unwound.

That is, when an upward sloped surface is formed in a reverse rotation direction and the handle 46 is turned in the reverse direction, the arrest part 56 is not caught in the arrest recess of the rotary shaft 54, preventing the wire rope 102 from being unwound.

A spring 58 is provided on the opposite side of the arrest piece, i.e., the other side of the arrest part 56, and here, the spring 58 is installed to be contracted by a support member 60.

The support member 60 is installed to be fixed to the handle 46 by screwing and the spring 58 is supported to be contracted, and in this state, the arrest part 56 is pushed in an arrest direction so that an arrest protrusion is caught n the arrest recess of the rotary shaft 54 when the handle 46 rotates.

In the present invention, in a state in which the wire rope 102 is wound around the first winding part 4, the handle 46 is folded as illustrated in FIG. 1, and in case where the wire rope 102 is wound after the descending apparatus 100 is used, the cover 64 and the handle 64 accommodated inside the cover 62 are sequentially unfolded to allow the wire rope 102 is wound as illustrated in FIG. 10.

That is, when the handle 46 is not in use, the handle 46 does not excessively protrude to the outside so that there is no trouble when the descending apparatus is used, and when the wire rope 102 is wound, the handle 46 may be spread to be used.

Also, when the escaper descends using the descending apparatus 100, the handle 46 does not rotate due to the reverse rotation preventing structure, and thus, the user may safely descend.

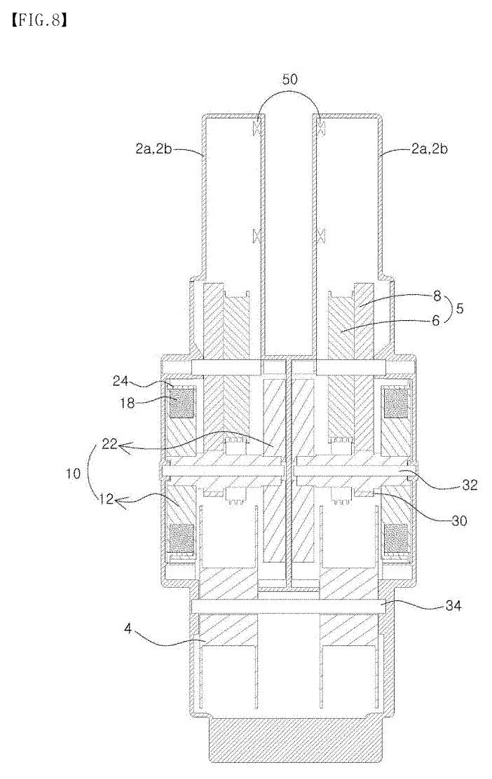

FIG. 8 illustrates a configuration of the descending apparatus 100 according to another embodiment of the present invention, in which, after the descending apparatus 100 is used, the escaper may escape continuously using the descending apparatus 100, even without re-winding the wire rope 102 with the handle 46.

Referring to FIG. 8, two descending apparatuses 100 are installed inside a case and alternately used. Here, after the escaper descends to reach the ground using descending apparatus 100 on one side, when the escaper uses the descending apparatus 100 on the other side, the unwound wire rope 102 may be automatically wound, thus allowing for continuous use.

In detail, the first and second winding parts 4 and 5 and the decelerating device 10 are provided respectively on the left and right inside the cases, and in particular, the first winding parts 4 around which the wire rope 102 is wound may be connected to each other to rotate cooperatively.

The wire ropes 102 are wound around the left and right first winding parts 4 connected to rotate by an interlocked rotary shaft 34 in opposite directions to each other, and accordingly, the wire rope 102 on one side is rotated, the wire rope 102 on the other side may be wound, whereby the descending apparatus 100 may be alternately used.

Here, when the descending apparatus 100 is first used in a state in which the wire rope 102 is wound around both the descending apparatuses 100, the first winding part 4 on one side rotates as the wire rope 102 wound around the first winding part 4 on one side is unwound, and in this case, the first winding part 4 on the other side does not rotate together as the wire rope 102 is already wound around the first winding part 4 on the other side.

That is, although the first winding part 4 on one side rotates, the first winding part 4 on the other side does not rotate and only the interlocked rotary shaft 34 rotates idle, and accordingly, only the wire rope 102 of the first winding part 4 on one side is unwound.

When the escaper completes descending to the ground using the descending apparatus on one side 100, the wire rope 102 is in an unwounded state, and when a next escaper descends to the ground using the descending apparatus 100 on the other side, the wire rope 102 is unwound and the first winding part 4 in a state in which the wire rope 102 is unwound therefrom is rotated by the interlocked rotary shaft 34 and the unwound wire rope 102 is automatically wound again.

By repeating this, winding and unwinding of the wire rope 102 of the descending apparatuses 100 are automatically performed, and since the wire rope 102 unwound after the use of the descending apparatuses 100 is not required to be wound manually, obtaining escaper convenience. Accordingly, in case where there are multiple escapers, the descending apparatuses 100 may be continuously used, reducing life damage.

In the present invention, an Internet of things (IOT) system capable of automatically reporting an emergency situation to a nearby fire station when the descending apparatus 100 operates may be applied.

After the descending apparatus 100 is installed to perform wireless communication with a wireless AP in an indoor area, when the descending apparatus 100 operates, a corresponding operating signal may be transmitted to the wireless AP. The wireless AP then may automatically transmit a preset emergency rescue signal to the nearby fire station, or the like, so that the user does not need to report in the emergency situation.

In an emergency situation, the user may be in a hurry to escape and cannot afford to report it. Also, in the case of multiplex housing such as apartments, a person directly concerned may escape but those who live in upper or lower apartment may fail to recognize a fire or an emergency situation, which may lead to a mass mortality event.

In order to prevent this, when the person directly concerned recognizes the emergency situation and uses the descending apparatus 100 to escape, the emergency situation may be sensed and automatically reported.

In addition, a sensing unit such as a monitoring camera or a fire detection sensor may be installed in a house, and when a fire breaks out or smoke occurs, sensing information may be transmitted to a dedicated application of a smartphone of the user through the wireless AP, so that the user may check the fire situation and the fire may be automatically reported to the fire station.

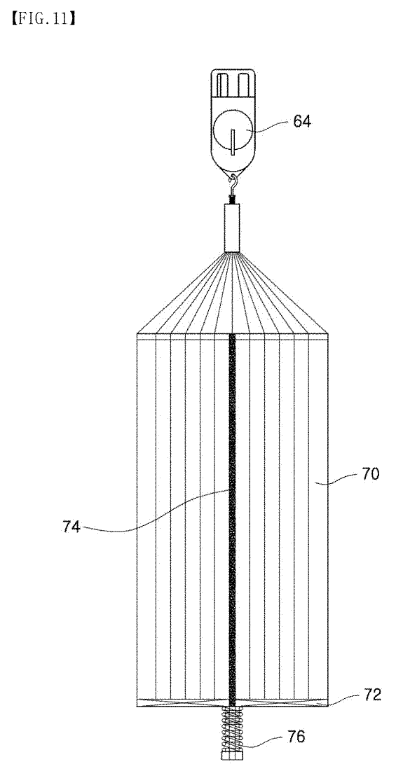

In the present invention, as illustrated in FIG. 11, a separate elevator 70 may be installed so that the elderly or a child may escape using the descending apparatus 100.

Generally, the elderly who are uncomfortable to move or a frightened child may not be able to descend quickly or may be too scared to descend when using the descending apparatus 100 on a high floor in an apartment.

To this end, the elevator 70, which may be installed at a lower ring of the descending apparatus 100, may be separately provided and the elderly or a child may get in the elevator 70 from a veranda to escape.

As illustrated in FIG. 11, the elevator 70 is normally folded to minimize the space, and in an escape situation, the folded elevator 70 may be widely unfolded like a folded umbrella is spread so that the elderly or a child may get therein.

A bottom plate 72 having a plurality of ribs are provided on the bottom of the elevator 70 to withstand a predetermined weight and formed to be foldable on a side surface so as to be easily folded and unfolded. A safety bar 74 allowing an occupant to grip may be installed inside the elevator 70.

A safety spring 76 may be installed at a lower portion of the elevator 70 to alleviate an impact when the elevator 70 descends and is brought into contact with the ground, so that the occupant may safely arrive at the ground.

The safety spring 76 may also be installed between the descending apparatus 100, an upper side of the elevator 70, and the elevator 70. When the safety spring 76 is installed between the descending apparatus 100 and the elevator 70, an impact may be first alleviated through the safety spring 76, thus preventing a large amount of force from being applied to the wire rope 102 due to sudden descending.

Reference numeral 50 denotes a guide roller guiding the wire rope 102 to be drawn in and out.

While the present invention has been shown and described in connection with the embodiments, it will be apparent to those skilled in the art that modifications and variations may be made without departing from the spirit and scope of the invention as defined by the appended claims.

What is claimed is:

1. A descending apparatus for emergency escape,
wherein a first winding part around which a wire rope is wound and a second winding part positioned above the first winding part and rotating to allow the wire rope unwound from the first winding part to be re-wound therearound to generate braking power are configured on an inner side of a case, a decelerating device controlling a descending rate of the descending apparatus by reducing a rotation rate of the second winding part by the braking power generated according to rotation of the second winding part when the wire lope is unwound as the descending apparatus descends are configured on both sides of the first and second winding parts, an operating lever adjusting a descending rate of the descending apparatus by controlling a rotation rate of the second winding part according to an operation of an escaper when descending using the descending apparatus is configured at an upper portion of the case, and a handle 46 is provided to allow the wire rope to be wound therearound to re-use the descending apparatus.

2. The descending apparatus of claim 1, wherein
the second winding part includes a winding roller around which the wire rope unwound from the first winding part is wound, a first gear fixed to and installed on a side surface of the winding roller and rotating together with the winding roller, and a plurality of auxiliary rollers guiding the wire rope to be wound around the winding roller.

3. The descending apparatus of claim 2, wherein
the decelerating device includes a first braking part generating braking power upon receiving a rotational force from the first gear of the second winding part, a second braking part generating braking power as the escaper using the descending apparatus operates the operating lever to adjust a descending rate, and a second gear connected to the first and second braking parts by a deceleration rotary shaft and rotating in mesh with the first gear installed on an upper side to transmit braking power.

4. The descending apparatus of claim 3, wherein
the first braking part includes a brake pad wheel having space parts formed by a plurality of partitions, brake pads respectively positioned in the space parts, and a friction band adjusting a rotation rate of the brake pad wheel according to frictional force with the brake pad.

5. The descending apparatus of claim 3, wherein
the second braking part includes a brake drum fixed and rotated by the second gear and the deceleration rotary shaft, a brake lining integrally fixed to and installed on an outer side of the brake drum, and a brake shoe reducing a rotation rate of the brake drum by a frictional force between the brake shoe and the brake lining.

6. The descending apparatus of claim 1, wherein
two operating levers are installed to allow the escape to operate the operating levers with both hands.

7. The descending apparatus of claim 1, wherein
the pair of first and second winding parts and the pair of decelerating devices are respectively installed on the left and right inside case so that the descending apparatus is continuously used. First and second winding parts, decelerating devices

8. The descending apparatus of claim 1, wherein
the handle for winding manually the wire rope unwound as the descending apparatus descends is installed on an outer side of the cases.

9. The descending apparatus of claim 1, wherein
an elevator is installed at the descending apparatus so that the elderly and a child to get therein to escape.
